(19) United States
(12) Patent Application Publication
(10) Pub. No.: US 2026/0301995 A1
(43) Pub. Date: Oct. 1, 2026

(54) WIRE HARNESS, HARNESS IDENTIFICATION SYSTEM, AND IN-VEHICLE DEVICE

(71) Applicants: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(72) Inventor: Yuta MIYAGAWA, Osaka-shi, Osaka (JP)

(73) Assignees: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(21) Appl. No.: 19/480,179

(22) PCT Filed: May 2, 2023
(86) PCT No.: PCT/JP2023/017100

§ 371 Date: Oct. 30, 2025

(51) Int. Cl. H01B 11/00; B60R 16/02; B60R 16/023; H01B 7/00; H01B 7/32

(52) U.S. Cl. CPC H01B 11/00; B60R 16/0207; B60R 16/023; H01B 7/0045; H01B 7/32

(57) ABSTRACT

A wire harness configured to connect communication between a first communication unit and a second communication unit includes: a transmission line provided between the first communication unit and the second communication unit, and configured to transmit a signal from at least one of the first communication unit and the second communication unit; and a filter unit provided at a predetermined position of the transmission line, and having a predetermined characteristic.

### CROSS-REFERENCE TO RELATED APPLICATIONS

This application is the U.S. national stage of PCT/JP2023/017100 filed on May 2, 2023, the content of which is incorporated herein.

### TECHNICAL FIELD

The present disclosure relates to a wire harness, a harness identification system, and an in-vehicle device.

### BACKGROUND

Various in-vehicle devices are mounted in a vehicle. The in-vehicle devices include various electronic control units (ECUs) that perform functions necessary for the vehicle, such as steering and braking. These ECUs are connected to each other, thus forming a network. The ECUs communicate with each other via the network, thus achieving basic functions of the vehicle, such as “running”, “turning”, and “stopping”. Usually, a wire harness is used for connection between the in-vehicle devices.

Such in-vehicle devices require a technique for protecting the in-vehicle devices (ECUs) against hacking or data falsification. WO 2019/187349 listed below proposes a connector system for preventing communication between a wire harness and an unintentional device.

The connector system described in WO 2019/187349 includes a first connector and a second connector connected thereto. The second connector includes a processing unit configured to perform processing for creating verification information and transmitting the verification information to the first connector. The first connector includes a verification unit configured to verify the second connector, based on the verification information received from the second connector. If the verification unit is unable to receive the verification information, the verification unit determines the verification has failed. The first connector further includes a switch configured to, in a state in which the first connector is connected to the second connector, select whether or not to electrically connect a transmission line in the first connector and a transmission line in the second connector to each other, and a control unit configured to control the switch, based on a result of the verification performed by the verification unit.

If the second connector is an unauthorized connector, the verification unit of the first connector determines that the verification has failed. The control unit of the first connector maintains the switch in an off stat. Consequently, the electrical connection between the transmission line of the first connector and the transmission line of the second connector is interrupted. Because the wire harness can be prevented from communicating with an unintentional device, it is possible to ensure security for communication between devices.

The connector system described in WO 2019/187349 is an excellent system from the viewpoint of ensuring security. However, the processing unit, the verification unit, and the control unit are achieved by electronic devices, and the electronic devices and the switch are built into the connector, and therefore it is difficult to simplify the configuration. Accordingly, the manufacturing cost tends to be expensive.

The present disclosure has been made in order to solve the above-described problem, and it is an object of the present disclosure is to provide a wire harness, a harness identification system, and an in-vehicle device that contribute to an improvement in security for communication with a simple configuration.

### SUMMARY

A wire harness according to a certain aspect of the present disclosure is a wire harness configured to connect communication between a first communication unit and a second communication unit, the wire harness including: a transmission line provided between the first communication unit and the second communication unit, and configured to transmit a signal from at least one of the first communication unit and the second communication unit; and a filter unit provided at a predetermined position of the transmission line, and having a predetermined characteristic.

The present disclosure can be achieved not only as a wire harness, a harness identification system, or an in-vehicle device including such a characteristic configuration, but also as a recording medium having recorded thereon a program for causing a computer to execute characteristic steps executed by the in-vehicle device or the harness identification system. Furthermore, the present disclosure can also be realized as other systems or devices including the wire harness, the harness identification system, or the in-vehicle device.

### Effects of the Present Disclosure

According to the present disclosure, it is possible to provide a wire harness, a harness identification system, and an in-vehicle device that contribute to an improvement in security for communication with a simple configuration.

### BRIEF DESCRIPTION OF DRAWINGS

FIG. 1 is a diagram illustrating an exemplary configuration of a system according to a first embodiment.

FIG. 2 is a diagram illustrating an exemplary configuration of a wire harness shown in FIG. 1.

FIG. 3A is a diagram illustrating an example of a filter unit provided in the wire harness shown in FIG. 1, and also illustrating an example of an open stub constituting the filter unit.

FIG. 3B is a diagram illustrating an example of the filter unit provided in the wire harness shown in FIG. 1, and also showing an example of the frequency characteristic of the open stub.

FIG. 4 is a diagram illustrating a characteristic of the filter unit provided in the wire harness shown in FIG. 1.

FIG. 5 is a diagram showing an exemplary configuration of an in-vehicle device shown in FIG. 1.

FIG. 6 is a block diagram showing an exemplary configuration of an identification device shown in FIG. 5.

FIG. 7 is a diagram showing an example of the characteristics of a filter unit of a wire harness according to a second embodiment.

FIG. 8 is a diagram illustrating an exemplary configuration of a wire harness according to a third embodiment.

FIG. 9A is a diagram illustrating a filter unit provided in the wire harness shown in FIG. 8, and also showing an example of a filter exhibiting a capacitive reflection characteristic.

FIG. 9B is a diagram illustrating the filter unit provided in the wire harness shown in FIG. 8, and also showing an example of a filter exhibiting an inductive reflection characteristic.

FIG. 10 is a diagram showing an example of the characteristics of the filter unit of the wire harness according to the third embodiment.

FIG. 11 is a diagram illustrating an exemplary configuration of a wire harness according to a fourth embodiment.

FIG. 12 is a diagram illustrating an exemplary configuration of a wire harness according to a fifth embodiment.

FIG. 13 is a diagram illustrating a characteristic of a filter unit provided in the wire harness shown in FIG. 12.

FIG. 14 is a diagram showing an exemplary configuration of an in-vehicle device according to a sixth embodiment.

### DETAILED DESCRIPTION OF PREFERRED EMBODIMENTS

Preferred embodiments of the present disclosure will be listed and described. At least some of the embodiments described below may be combined freely.

In a first aspect, a wire harness according to a first aspect of the present disclosure is a wire harness configured to connect communication between a first communication unit and a second communication unit, the wire harness including: a transmission line provided between the first communication unit and the second communication unit, and configured to transmit a signal from at least one of the first communication unit and the second communication unit; and a filter unit provided at a predetermined position of the transmission line, and having a predetermined characteristic.

The filter unit having a predetermined characteristic is provided at a predetermined position of the transmission line. By transmitting, for example, a diagnosis signal to the transmission line, a signal according to the characteristic of the filter unit is generated. On the other hand, in a wire harness in which the filter unit is not provided, such a signal will not be generated. Accordingly, based on whether a signal (reflection) according to the characteristic of the filter unit is included in a reflection waveform for the diagnosis signal, it is possible to determine whether the connected wire harness is a legitimate wire harness. That is, it is possible to determine the authenticity of the connected wire harness. This makes it possible to detect that the legitimate wire harness is not connected (an unauthorized wire harness has been connected). By stopping (interrupting) communication if connection of an unauthorized wire harness is detected, it is possible to prevent communication with an unintentional device. This can prevent hacking or data falsification against an in-vehicle device. In this manner, the wire harness according to the present disclosure can contribute to an improvement in security for communication with a simple configuration.

In a second aspect according to the first aspect, the filter unit may be configured to filter a signal outside a communication band used for communication between the first communication unit and the second communication unit. Accordingly, the filter unit can be provided on the communication transmission line, thus making it possible to further simplify the configuration.

In a third aspect according to the first aspect, the transmission line may include a line that is not used for communication between the first communication unit and the second communication unit. A transmission line for identifying whether the wire harness is a legitimate wire harness is provided separately from the communication transmission line. This allows the characteristic of the filter unit to be set without being limited to a communication band, and it is therefore possible to increase the degree of freedom of design.

In a fourth aspect according to any one of the first to the third aspects, the filter unit may include an open stub having a predetermined length, and the predetermined characteristic may include a capacitive reflection characteristic. Accordingly, the filter unit having a predetermined characteristic can be easily formed.

In a fifth aspect according to any one of the first to the third aspects, the filter unit may include a plurality of open stubs having predetermined lengths, and the plurality of open stubs may be respectively provided at predetermined positions of the transmission line. Accordingly, the authenticity of the wire harness can be determined based on a plurality of signals, and it is therefore possible to increase the determination accuracy.

In a sixth aspect according to the fifth aspect, the lengths of the plurality of open stubs may be different from each other. Accordingly, the pattern of the plurality of signal can be changed, and it is therefore possible to easily change the detection pattern for the authenticity determination.

In a seventh aspect according to any one of the first to the third aspects, the filter unit may be configured to have the predetermined characteristic by varying a line width of the transmission line. This facilitates formation of the filter unit, thus making it possible to easily reduce the manufacturing cost.

In an eight aspect according to the seventh aspect, the filter unit may include a filter region having an inductive reflection characteristic, or a filter region having a capacitive reflection characteristic. When the filter unit includes a filter region having an inductive reflection characteristic, the filter region having an inductive reflection characteristic can be formed, for example, by reducing the line width of the transmission line to be smaller than the line widths of the transmission line in regions other than the region in which the filter unit is provided. This makes it possible to easily achieve a wire harness that contributes to an improvement in security for communication with a simple configuration.

On the other hand, when the filter unit includes a filter region having a capacitive reflection characteristic, the filter region having a capacitive reflection characteristic can be formed, for example, by increasing the line width of the transmission line to be larger than the line widths of regions other than the region in which the filter unit is provided. Accordingly, this also makes it possible to easily achieve a wire harness that contributes to an improvement in security for communication with a simple configuration.

In a ninth aspect according to any one of the first to the eighth aspects, the filter unit may include a plurality of filters having different reflection characteristics. This makes it possible to detect that a legitimate wire harness is not connected (an unauthorized wire harness has been connected).

In a tenth aspect according to the ninth aspect, the filter unit may be provided at a predetermined position of the transmission line. This makes it possible to determine the authenticity of the connected wire harness, based on the information on the position at which the filter unit is provided.

In an eleventh aspect according to the tenth aspect, the wire harness may further include a connector provided at an end portion of the transmission line, wherein the filter unit may be located inside the connector. This can reduce a difference in appearance caused by the presence or absence of the filter unit. That is, the provision of the filter unit can be made less visible from the appearance.

In a twelfth aspect according to the eleventh aspect, the wire harness may further include a sheet-shaped holding member configured to hold the transmission line. This facilitates formation of the filter unit having a predetermined characteristic.

In a thirteenth aspect, a harness identification system according to a second aspect of the present disclosure includes: a wire harness; and an identification device configured to identify whether the wire harness is legitimate. The wire harness includes: a transmission line configured to transmit a signal; and a filter unit provided at a predetermined position of the transmission line, and having a predetermined characteristic. The identification device includes: a signal transmission unit configured to transmit an identification signal to the transmission line; a signal reception unit configured to receive a reflection waveform of the identification signal; and an identification unit configured to identify authenticity of the wire harness, based on whether a signal generated by the filter unit and having the predetermined characteristic is included in the received reflection waveform. This makes it possible to detect that a legitimate wire harness is not connected (an unauthorized wire harness has been connected). By stopping communication if connection of an unauthorized wire harness is detected, it is possible to prevent communication with an unintentional device. Accordingly, it is possible to contribute to an improvement in security for communication with a simple configuration.

In a fourteenth aspect, an in-vehicle device according to a third aspect of the present disclosure is an in-vehicle device configured to be mounted in a vehicle, the in-vehicle device including: a connector to which a wire harness is connected; a substrate on which an electronic component is mounted; a transmission line configured to transmit a signal between the electronic component and the wire harness; and a filter unit provided at a predetermined position of the transmission line, and having a predetermined characteristic. This makes it possible to contribute to an improvement in security for communication with a simple configuration.

Specific examples of a wire harness, a harness identification system, or an in-vehicle device according to embodiments of to the present disclosure will be described below with reference to the drawings. Note that the same components are denoted by the same reference numerals in the following embodiments. The functions and the names of those components are also the same. Therefore, the detailed descriptions thereof will not be repeated.

### First Embodiment

### Overall Configuration

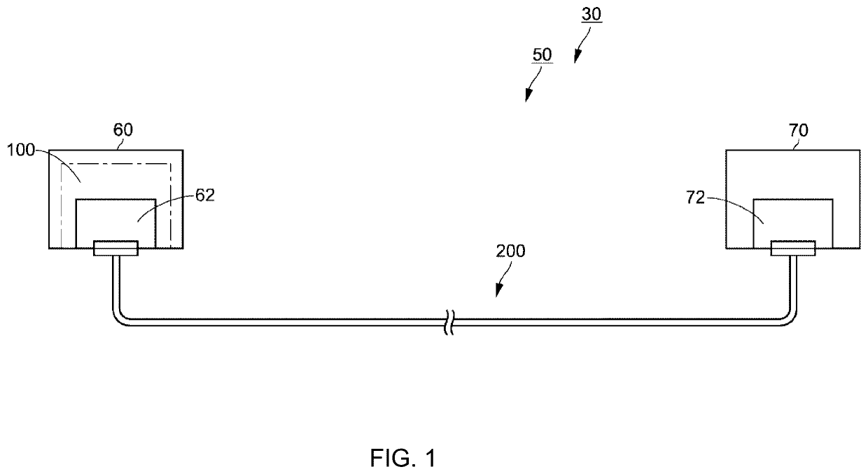

Referring to FIG. 1, a harness identification system 50 according to the present embodiment includes an identification device 100 that identifies whether a wire harness connected thereto is legitimate, and a wire harness 200 that connects communication between devices. The harness identification system 50 is mounted in a vehicle 30, for example. Various in-vehicle devices, including a first in-vehicle device 60 and a second in-vehicle device 70, are mounted in the vehicle 30.

The first in-vehicle device 60 includes a first communication unit 62. The second in-vehicle device 70 includes a second communication unit 72. The wire harness 200 connects communication between the first communication unit 62 and the second communication unit 72. The wire harness 200 may be directly connected to the first communication unit 62 and the second communication unit 72, or may be indirectly connected thereto via another wire harness and the like.

The identification device 100 is provided in the first in-vehicle device 60. Note, however, that the present disclosure is not limited to such a configuration. The identification device 100 may be configured to be provided in the second in-vehicle device 70, or may be configured to be provided in both the first in-vehicle device 60 and the second in-vehicle device 70.

An ECU, which is a kind of in-vehicle device, may have cable fault diagnosis function using Time Domain Reflectometry (TDR). The TDR refers to a method involving transmitting a pulse signal or a step signal to an object to be measured, and observing a returned reflection waveform, thereby measuring a change in characteristic impedance on a transmission line. By observing a change in characteristic impedance, a cable fault such as breaking is detected.

The first in-vehicle device 60 is an ECU having such a function, and the identification device 100 uses this diagnosis function to identify whether a wire harness connected thereto is a legitimate wire harness 200. That is, the identification device 100 uses the diagnosis function of the ECU not for fault diagnosis, but for identification (authentication) of whether a wire harness is a legitimate wire harness 200.

When the first in-vehicle device 60 and the second in-vehicle device 70 are ECUs, the first communication unit 62 and the second communication unit 72 each include a physical layer (PHY). The PHY mediates between a microcontroller included in an ECU and a communication medium.

### Wire Harness 200

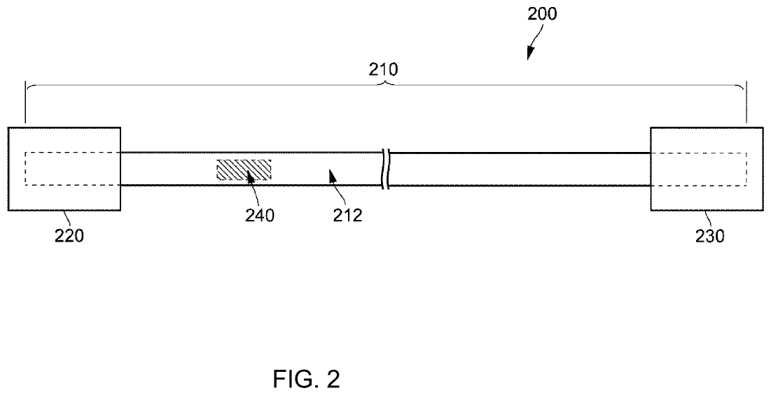

Referring to FIG. 2, the wire harness 200 according to the present embodiment includes a wire unit 210, a first connector 220 provided at a first end portion, which is one end portion of the wire unit 210, a second connector 230 provided at a second end portion, which is the other end portion of the wire unit 210, and a filter unit 240 having a predetermined characteristic. The wire unit 210 is, for example, a wire or a cable, and includes a transmission line 212 configured to transmit signals. The transmission line 212 is coated with an insulating material. The filter unit 240 is provided at a predetermined position of the transmission line 212. In the present embodiment, the filter unit 240 is provided at a position of the transmission line 212 that is located outside the connectors.

The filter unit 240 includes a filter having a characteristic of blocking a predetermined frequency. As described above, the identification device 100 uses the characteristic of the filter unit 240 for authentication (identification) of the wire harness 200. Specifically, the identification device 100 identifies whether the wire harness connected thereto is the wire harness 200, based on whether a reflection (reflection signal) generated by the filter unit 240 is included in a reflection waveform obtained by the TDR method.

More specifically, due to the provision of the filter unit 240 on the transmission line 212, a reflection (reflection signal) according to the characteristic of the filter unit 240 is included in a reflection waveform of an input pulse signal or a step signal (also called an “identification signal” or an “input signal”) in a predetermined frequency band. Accordingly, whether the connected wire harness is the wire harness 200 can be determined depending on the presence or absence of a reflection according to the characteristic of the filter unit 240. That is, information detected by the filter unit 240 is used for identification of the wire harness 200. Therefore, depending on whether or not a signal resulting from the characteristic of the filter unit 240 is detected, it is possible to identify whether the connected wire harness is a legitimate wire harness 200 or an unauthorized wire harness different from the wire harness 200.

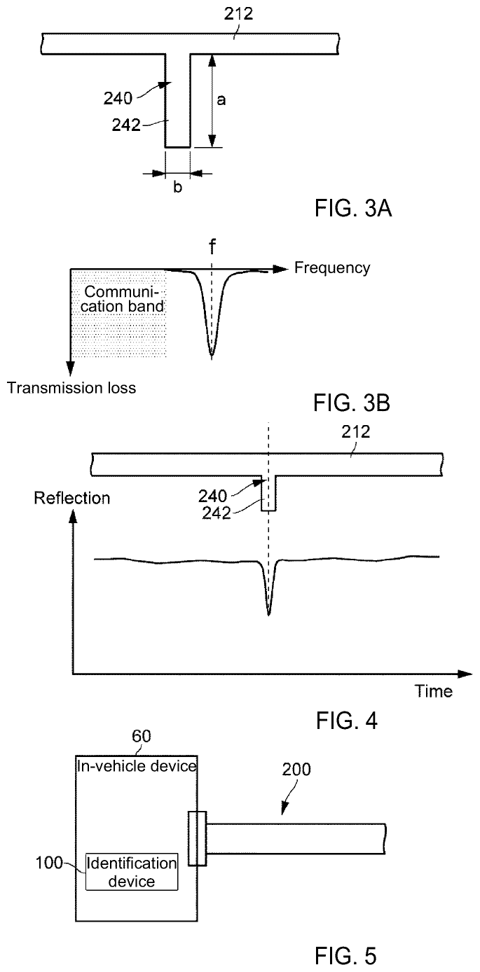

Referring to FIGS. 3A and 3B, the filter unit 240 includes an open stub 242. FIG. 3A shows an example of the open stub. FIG. 3B shows a frequency characteristic of the open stub. The horizontal axis of FIG. 3B represents the frequency, and the vertical axis represents the transmission loss. Referring to FIG. 3B, the open stub 242 functions as a filter circuit that attenuates only a specific (resonance frequency f) band to an extremely low level. That is, the open stub 242 functions as a band reject filter exhibiting a short-circuit characteristic at the resonance frequency f.

The resonance frequency f is controlled by a length (electrical length) a of the open stub 242, and the bandwidth thereof is controlled by a width b of the open stub 242. The shape (length a and width b) of the open stub 242 is set such that the resonance frequency f is located in a predetermined band. In the present embodiment, the shape of the open stub 242 is set such that the resonance frequency f is located outside a communication band. Accordingly, the open stub 242 functions as a filter having a blocking characteristic outside the communication band. The filter unit 240 configured in this manner can also be regarded as an out-of-band signal filter unit configured to filter signals outside the communication band. Note that, in the present disclosure, a “communication band” means a frequency band used for communication between devices, including, for example, a band that satisfies the frequency characteristics prescribed in a standard such as IEEE 802.3 (registered trademark). Because the open stub 242 functions as a filter having a characteristic outside the communication band, the provision of the open stub 242 on the transmission line 212 does not affect the quality of communication signals (signals in the communication band).

FIG. 4 is a graph showing an example of the reflection characteristic of the filter unit 240 (open stub 242). FIG. 4 shows an example of the reflection waveform of the transmission line 212 that is obtained ty the TDR method. The horizontal axis of FIG. 4 represents the time, and the vertical axis represents the reflection waveform impedance (simply shown as “Reflection” on the graph). Referring to FIG. 4, when the open stub 242 is provided on the transmission line 212, the open stub 242 exhibits a capacitive reflection characteristic. The portion in which the open stub 242 is provided has a lower impedance than the other portions. As for the reflection characteristic of the open stub 242, the reflection depth is controlled by the length a (FIG. 3A) of the open stub 242, and the time width is controlled by the width b (FIG. 3A) of the open stub 242. In this case, the frequency band of input signals used for the TDR method can be a frequency band outside the communication band.

### Identification Device 100

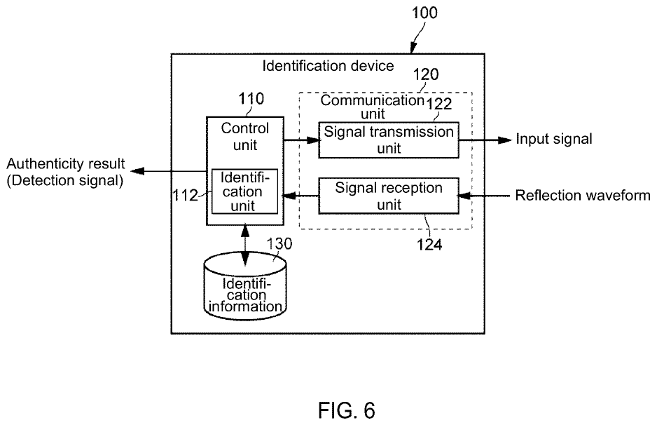

Referring to FIG. 5, the identification device 100 is provided in the first in-vehicle device 60 as described above. Referring to FIG. 6, the identification device 100 includes a control unit 110, a communication unit 120, and a memory 130. The control unit 110 includes, for example, an arithmetic element (processor) such as a central processing unit (CPU) or a micro processing unit (MPU). The control unit 110 includes, as a functional unit, an identification unit 112 configured to identify whether the wire harness is a legitimate wire harness using the TDR method.

The communication unit 120 includes a signal transmission unit 122 and a signal reception unit 124. Under control of the control unit 110, the signal transmission unit 122 transmits an identification signal (input signal) to the transmission line of a wire harness. The signal reception unit 124 receives a reflection waveform returned from the transmission line of the wire harness, and provides the received reflection waveform to the identification unit 112. The memory 130 includes a nonvolatile memory such as a flash memory. The memory 130 stores software (a computer program) executed by the control unit 110 (identification unit 112), and various types of information (data). The memory 130 further stores identification information for determining whether a reflection (reflection signal) according to the characteristic of the filter unit 240 (open stub 242) is included in the reflection waveform. The identification information includes characteristic information of the filter unit 240 (open stub 242), for example. Specifically, the identification information includes at least one of a resonance frequency, a band thereof, a reflection characteristic (reflection depth or the like) of the open stub 242, and information on the position at which the open stub 242 is formed.

The identification unit 112 has the function of observing an input reflection waveform. With reference to the identification information stored in the memory 130, the identification unit 112 determines whether a waveform (waveform signal) generated by the filter unit 240 (open stub 242) is included in an input reflection waveform. Based on a result of the determination, the identification unit 112 identifies whether the wire harness is legitimate. That is, the identification unit 112 determines the authenticity of the wire harness.

Referring also to FIG. 2, the wire harness 200 includes the filter unit 240. Accordingly, when the wire harness 200 is connected, the identification unit 112 determines that the wire harness is legitimate, or “authentic”. On the other hand, when a wire harness other than the wire harness 200 is connected, the identification unit 112 determines that the wire harness is not legitimate, or “not authentic”. The identification unit 112 outputs the determination result (authenticity result) to the ECU (first in-vehicle device 60). If the authenticity result is “not authentic”, the ECU interrupts communication.

Such authentication processing (identification processing) may be performed constantly, or may be performed regularly or irregularly. In the case of performing the authentication processing irregularly, the processing may be performed when triggered by some event, or may be performed according to a preset schedule.

### Operations

Referring to FIG. 6, the signal transmission unit 122 of the identification device 100 transmits an identification signal (input signal) to the transmission line. The signal reception unit 124 of the identification device 100 receives a reflection signal (reflection waveform) of the identification signal transmitted by the signal transmission unit 122.

Referring to FIGS. 3A, 3B, and 4, the input signal is filtered by the filter unit 240 (open stub 242). Accordingly, a reflection (reflection signal) according to the characteristic (shape) of the open stub 242 is included in the reflection waveform.

Referring again to FIG. 6, with reference to the information (identification information) in the memory 130, the identification device 100 determines whether a reflection generated by the filter unit 240 is included in the reflection waveform received via the signal reception unit 124. Based on a result of the determination, the identification device 100 identifies whether the connected wire harness is legitimate. The identification device 100 transmits the authenticity result to the ECU. If the authenticity result is “not authentic”, the ECU interrupts communication.

The identification unit 112 may output a determination result (authenticity result) only if the authenticity result is “not authentic”. For example, only if connection of an unauthorized wire harness is detected, the identification unit 112 may output a signal (e.g., a detection signal or a communication interruption signal) for notifying to that effect.

In the wire harness 200 according to the present embodiment, the filter unit 240 having a predetermined characteristic is provided at a predetermined position of the transmission line 212. By transmitting a diagnosis signal to the transmission line 212, a signal (reflection) according to the characteristic of the filter unit 240 is generated. On the other hand, in a wire harness in which the filter unit 240 is not provided, such a signal (reflection according to the filter characteristic) will not be generated. Accordingly, based on whether a signal (reflection) according to the characteristic of the filter unit 240 is included in a reflection waveform of the diagnosis signal, it is possible to determine whether the connected wire harness is the legitimate wire harness 200. That is, it is possible to determine the authenticity of the connected wire harness. This makes it possible to detect that the legitimate wire harness 200 is not connected (an unauthorized wire harness has been connected). By interrupting communication if connection of an unauthorized wire harness is detected, it is possible to prevent communication with an unintentional device. This can prevent hacking or data falsification against the in-vehicle device. In this manner, the wire harness 200 according to the present embodiment can contribute to an improvement in security for communication with a simple configuration.

The filter unit 240 filters signals outside a communication band used for communication between the first communication unit 62 and the second communication unit 72. Accordingly, the filter unit 240 can be provided on the transmission line 212 for communication, and it is therefore possible to further simplify the configuration.

The filter unit 240 includes the open stub 242 having a predetermined length. In this case, the characteristic of the filter unit 240 is a capacitive reflection characteristic. Accordingly, the filter unit 240 having a predetermined characteristic can be easily formed. By holding the information of the capacitive reflection characteristic as the identification information, it is possible to easily determine the authenticity of the wire harness.

### Second Embodiment

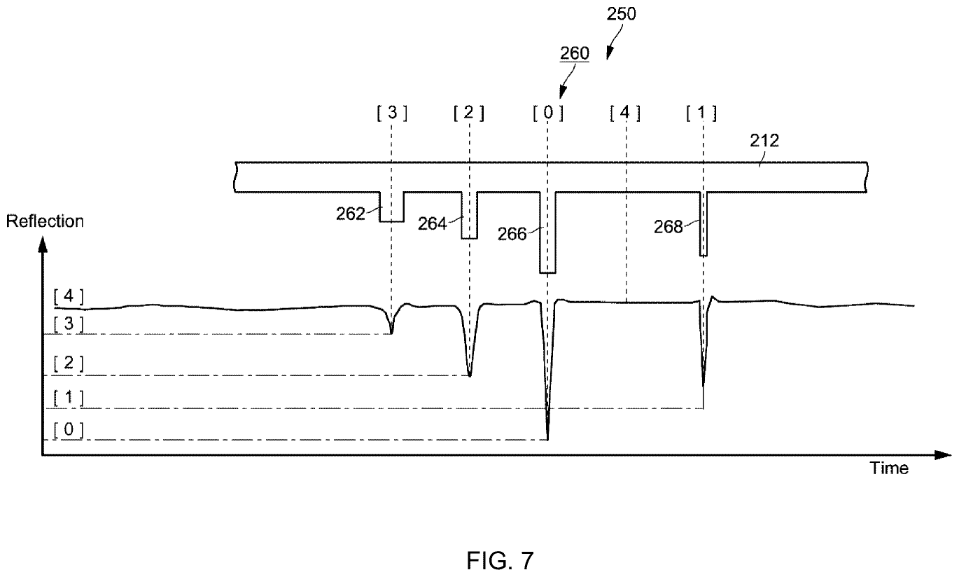

Referring to FIG. 7, a wire harness 250 according to the present embodiment differs from the first embodiment in that the wire harness 250 includes a plurality of open stubs. The wire harness 250 includes a filter unit 260 provided on a transmission line 212. The filter unit 260 includes a plurality of open stubs having predetermined lengths.

FIG. 7 shows an exemplary configuration in which four open stubs 262, 264, 266, and 268 are provided. Note, however, that the number of open stubs is not limited to four, and may be two, three, or five or more. The open stubs 262, 264, 266, and 268 are respectively provided at predetermined positions. Because the positional information of the open stubs can also be obtained by analyzing a reflection waveform by the TDR method, the positional information of the open stubs can also be used for the authentication of a wire harness. The positional information can be the distance from a reference point. Furthermore, the intervals between the open stubs may be used as the positional information. The intervals between the open stubs may be equal intervals or different intervals.

The open stubs 262, 264, 266, and 268 have lengths (electrical lengths) different from each other. Because the reflection depth is controlled by the open stub length, reflection waveforms of the portions in which the open stubs 262, 264, 266, and 268 are formed have different reflection depths. Note that the horizontal axis of FIG. 7 represents the time, and the vertical axis represents the reflection waveform impedance.

In a case where the plurality of open stubs 262, 264, 266, and 268 are provided in the form of a bar code as shown in FIG. 7, the magnitudes (depths) of reflections may be divided into several levels (grades), and classified according to the levels. For example, when the magnitudes (depths) of reflections are divided into five levels, the reflection of the open stub 266 having the largest electrical length is classified as [0], the reflections of the open stubs 262, 264, and 268 are classified as [3], [2], and [1], respectively, and the reflection at a position at which no open stub is provided is classified as [4]. In this manner, by classifying the depths of reflections generated by the open stubs 262, 264, 266, and 268 according to the levels, information detected by the filter unit 260 can be used as numerical information (identification code: e.g., [3, 2, 0, 4, 1]). The numerical information (identification code) can be changed by changing the number, lengths, or order of arrangement of the open stubs.

As described above, the filter unit 260 of the wire harness 250 according to the present embodiment includes the plurality of open stubs 262, 264, 266, and 268 having predetermined lengths, and the plurality of open stubs 262, 264, 266, and 268 are respectively provided at predetermined positions of the transmission line 212. Accordingly, the authenticity of the wire harness can be determined based on a plurality of signals, and it is therefore possible to increase the determination accuracy.

Furthermore, because the lengths of the plurality of open stubs 262, 264, 266, and 268 are different from each other, the occurrence pattern of the plurality of signal can be changed. This makes it possible to easily change the detection pattern for the authenticity determination.

Note that the lengths (electrical lengths) of the plurality of open stubs may be the same. Furthermore, the plurality of open stubs may include open stubs having the same length (electrical length).

The other configurations and effects are the same as those of the first embodiment.

### Third Embodiment

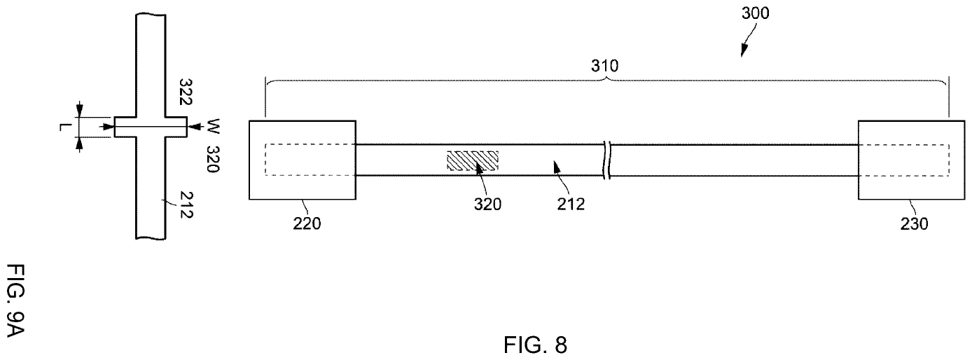

Referring to FIG. 8, a harness identification system according to the present embodiment includes a wire harness 300 in place of the wire harness 200 (see FIG. 2). The wire harness 300 includes a wire unit 310 in place of the wire unit 210 (see FIG. 2). The wire unit 310 includes a transmission line 212. A filter unit 320 is formed in place of the filter unit 240 (see FIG. 2) on the transmission line 212. In these respects, the present embodiment differs from the first or second embodiment.

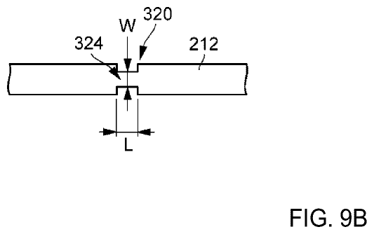

Referring to FIGS. 9A and 9B, the filter unit 320 includes a filter (filter region) provided at a predetermined position of the transmission line 212, and having a predetermined characteristic. The filter unit 320 (filter region) is configured to have the predetermined characteristic by changing (varying) the shape of the transmission line 212. Specifically, the filter unit 320 includes a filter region (filter 322: FIG. 9A) formed by increasing the thickness of the transmission line 212, or a filter region (filter 324: FIG. 9B) formed by reducing the thickness of the transmission line 212.

Referring to FIG. 9A, the filter 322 is set to have a line width W and a length L so as to have a predetermined characteristic. The line width W has a larger value than values thereof in regions of the transmission line 212 that are other than the region in which the filter unit 320 is provided. The filter 322 exhibits a capacitive reflection characteristic in measurement using the TDR method. The line width W controls the magnitude (lowness) of reflection, and the length L controls the time width of reflection.

Referring to FIG. 9B, the filter 324 is also set to have a line width W and a length L so as to have a predetermined characteristic. The line width W has a smaller value than values thereof in regions of the transmission line 212 that are other than the region in which the filter unit 320 is provided. The filter 324 exhibits an inductive reflection characteristic in measurement using the TDR method. The line width W controls the magnitude (highness) of reflection, and the length L controls the time width of reflection.

As in the case of the first embodiment, the shape of the filter is set such that the resonance frequency is located outside the communication band. That is, the filter unit 320 is formed so as to filter signals outside the communication band.

When the transmission line 212 is a wire, the above-described filter can be formed by partially changing the thickness of the transmission line 212. When the transmission line 212 is formed on a printed circuit board, for example, the above-described filter can be formed by patterning a conductive layer.

The filter unit 320 may be configured to include one of the filter 322 and the filter 324, or may also be configured to include both the filter 322 and the filter 324. Furthermore, the filter unit 320 may also be configured to include a plurality of filters 322 or filters 324.

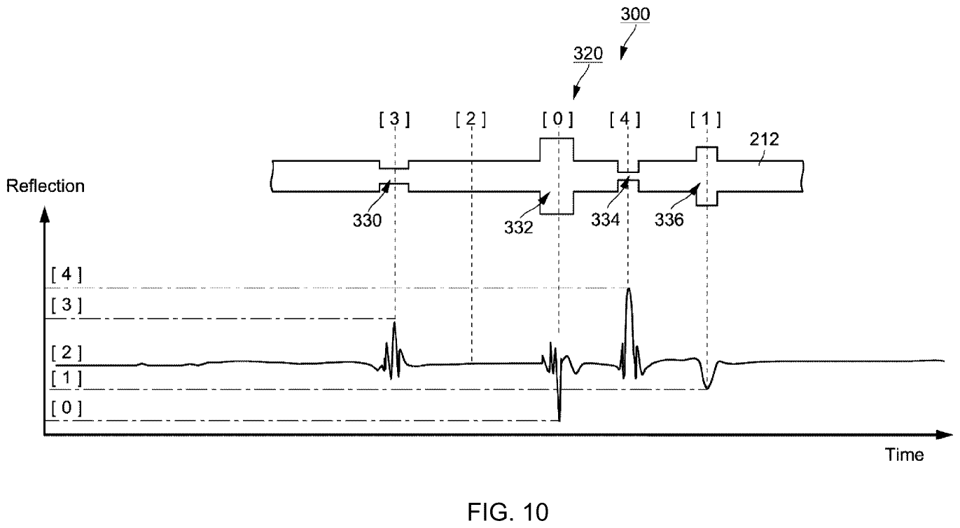

In a case where the filter unit 320 includes both the filter 322 and the filter 324, at least some of the filters may have shapes different from each other. FIG. 10 shows an example of a case where the filter unit 320 is configured in such a manner.

Referring to FIG. 10, the filter unit 320 includes for example, filters 330, 332, 334, and 336 formed on the transmission line 212. The number of filters formed is not limited to four, and may be two, three, or five or more. Note that the horizontal axis of FIG. 10 represents the time, and the vertical axis represents the reflection waveform impedance.

The filters 332 and 336 are classified as a group of the filters 322 shown in FIG. 9A. The filters 330 and 334 are classified as a group of the filters 324 shown in FIG. 9B. When the transmission line 212 on which the filter unit 320 is formed is measured using the TDR method, a capacitive (having a lower impedance than the transmission line 212) reflection is observed at locations (the positions of the filter 332 and the filter 336) at which the thickness is larger than that of the transmission line 212, and an inductive (having a higher impedance than the transmission line 212) reflection is observed at locations (the positions of the filters 330 and the filter 334) at which the thickness is smaller than that of the transmission line 212. These can be used as information on the location (position) and the highness/lowness of impedance as in the case where the open stubs are provided.

As in the case of the second embodiment, when the plurality of filters 330, 332, 334, and 336 are provided on the transmission line 212, the magnitudes (highness/lowness) of reflections may be divided into several levels (grades), and the highness/lowness of reflections may be classified according to the levels. For example, when the magnitudes (highness/lowness) of reflections are divided into five levels, the reflections of the filters 332 and 336 may be classified as [0] and [1], respectively, the reflections at the position (transmission line 212) at which no filter is provided may be classified as [2], and the reflections of the filters 330 and 334 may be classified as [3] and [4], respectively. In this manner, by classifying the highness/lowness of reflections generated by the filters 330, 332, 334, and 336 according to the levels, the information detected by the filter unit 320 can be used as numerical information (identification code: e.g., [3, 2, 0, 4, 1]). By changing the number, shapes, or order of arrangement of the filters, it is possible to change the numerical information (identification code).

In the present embodiment, as described above, the filter unit 320 is configured to have a predetermined characteristic by varying the line width of the transmission line 212. This facilitates the formation of the filter unit 320, thus making it possible to easily reduce the manufacturing cost.

The filter unit 320 may be configured to include a filter region (filter 324) that has an inductive reflection characteristic, and in which the line width of the transmission line 212 is smaller than that in regions of the transmission line 212 other than the region in which the filter unit 320 is provided. In this case, it is possible to easily achieve a wire harness that contributes to an improvement in security for communication with a simple configuration.

Furthermore, the filter unit 320 may be configured to include a filter region (filter 322) that has a capacitive reflection characteristic, and in which the line width of the transmission line 212 is larger than that in regions of the transmission line 212 other than the region in which the filter unit 320 is provided. Also in this case, it is possible to easily achieve a wire harness that contributes to an improvement in security for communication with a simple configuration.

The other configurations and effects are the same as those of the first or second embodiment.

### Fourth Embodiment

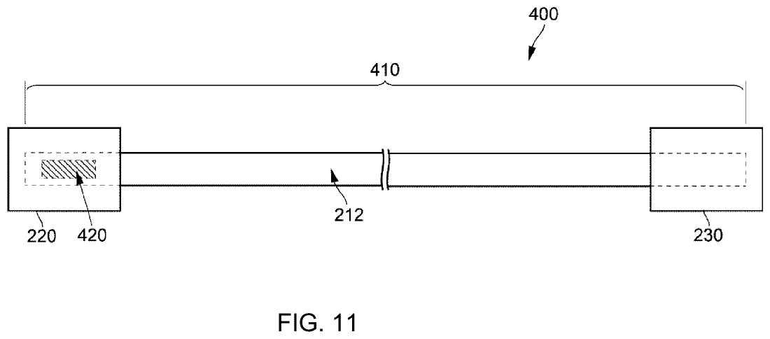

Referring to FIG. 11, a wire harness 400 according to the present embodiment differs from the first to third embodiments in that the wire harness 400 is configured such that a filter unit 420 is located inside a connector. The wire harness 400 includes a wire unit 410. The wire unit 410 includes a transmission line 212. The filter unit 420 is provided on the transmission line 212. The filter unit 420 may have the same configuration as the filter units described in the above-described the first to third embodiments.

In the present embodiment, the filter unit 420 is formed to be located inside the first connector 220. Note, however, that the filter unit 420 may also be formed to be located inside the second connector 230. Furthermore, a filter unit different from the filter unit 420 may also be additionally provided, and the additional filter unit may also be located inside the second connector 230. That is, filter units may also be provided in both the first connector 220 and the second connector 230.

In this manner, the filter unit 420 of the wire harness 400 is configured to be located inside the connector(s). That is, the filter unit 420 is built into the connector(s). This can reduce a difference in appearance caused by the presence or absence of the filter unit 420. That is, the provision of the filter unit 420 can be made less visible from the appearance. Note that, when the filter unit 420 is configured in this manner, it is also possible to simplify the configuration as compared with a case where an electronic device is built into the connector(s).

### Fifth Embodiment

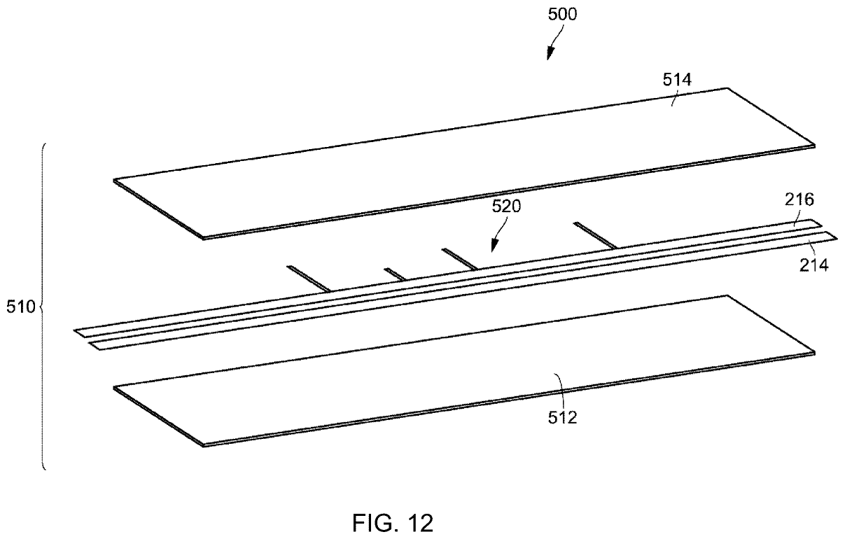

Referring to FIG. 12, a wire harness 500 according to the present embodiment includes a flat cable 510 serving as a wire unit. The flat cable 510 is a flat cable such as a flexible substrate (flexible printed circuit: FPC), and is provided with a plurality of wires.

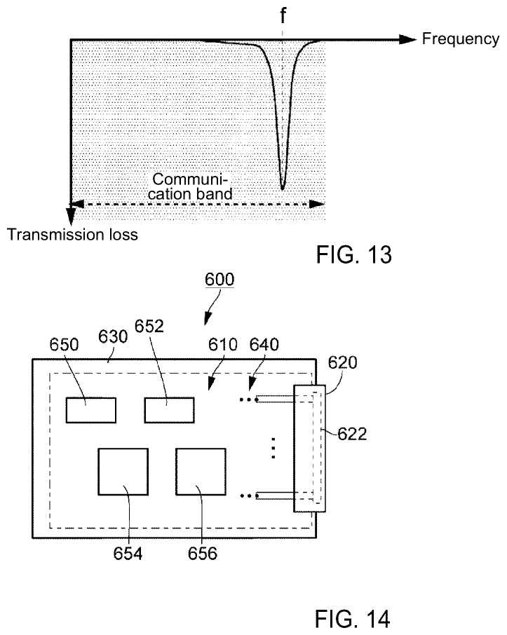

The flat cable 510 includes a communication transmission line 214, and an identification transmission line 216 that is not used for communication. The communication transmission line 214 is a line (wire) used for communication between the first communication unit 62 (FIG. 1) and the second communication unit 72 (FIG. 1). The identification transmission line 216 is a line (wire) that is dedicated to identification and is not used for communication between the first communication unit 62 (FIG. 1) and the second communication unit 72 (FIG. 1). A filter unit 520 is provided on the identification transmission line 216. The filter unit 520 includes a plurality of open stubs. In the present embodiment, the filter unit 520 is provided on the identification transmission line 216, and therefore the characteristic of the filter unit 520 is not limited to a frequency band. Referring to FIG. 13, the filter unit 520 can be configured such that, for example, the resonance frequency f is located inside the communication band.

The communication transmission line 214 and the identification transmission line 216 are each formed by a conductive layer. The flat cable 510 includes a base film 512 on which the communication transmission line 214 and the identification transmission line 216 are formed, and a cover film 514 that covers the communication transmission line 214 and the identification transmission line 216. The base film 512 and the cover film 514 are sheet shaped holding members, and hold the communication transmission line 214 and the identification transmission line 216. The base film 512 and the cover film 514 are each constituted by a flexible insulating film (sheet).

The flat cable 510 may be configured to further include other wires in addition to the communication transmission line 214 and the identification transmission line 216. The number of layers in on which the transmission lines are formed is not limited to one, and a plurality of layers may be stacked. The use of such a flat cable 510 as the wire unit facilitates working of the filter unit 520 when providing the filter unit 520 on the transmission line, and also makes it possible to easily achieve the positional accuracy.

Because the wire harness 500 according to the present embodiment is configured to include the sheet-shaped holding members configured to hold the transmission lines, the filter unit 520 having a predetermined characteristic can be easily formed.

An assembled harness such as e-STEALTH (registered trademark) is known as a wire harness using a flat cable. The wire harness 500 according to the present embodiment can also be formed using such an assembled harness.

Note that the connectors have been omitted in FIG. 12. As described in the fourth embodiment, the filter unit 520 may be provided inside the connector(s). Furthermore, at least some of the open stubs constituting the filter unit 520 may be replaced by the filters described in the third embodiment.

In the present embodiment, an example is described in which the identification transmission line 216 that is not used for communication is provided in the flat cable 510. However, the present disclosure is not limited to such an embodiment. The flat cable may be configured not to include the identification transmission line 216 that is not used for communication. In that case, the above-described filter unit may be provided on the communication transmission line.

### Sixth Embodiment

Referring to FIG. 14, an in-vehicle device 600 according to the present embodiment includes a filter unit 610 similar to a filter unit provided in a wire harness. That is, an identification filter unit 610 is provided in the in-vehicle device 600. Note, however, that the filter unit 610 is not intended for identification of a wire harness, but is intended for identification of an in-vehicle device. Specifically, the filter unit 610 is used for identifying whether an in-vehicle device connected to a wire harness is a legitimate in-vehicle device 600.

The in-vehicle device 600 includes a connector 620 to which a wire harness is connected, a substrate 630 on which electronic components are mounted, a transmission line 640 configured to transmit signals between the wire harness and the electronic components, and the above-described filter unit 610 provided at a predetermined position of the transmission line 640, and having a predetermined characteristic.

The substrate 630 is a printed circuit board (mounting substrate) on which the electronic components are mounted. FIG. 14 shows an example in which electronic components 650, 652, 654, and 656 are mounted on the substrate 630 as electronic components. The connector 620 includes a terminal portion 622. The terminal portion 622 of the connector 620 is electrically connected to a transmission line of the wire harness. The substrate 630 is provided with a transmission line 640 for electrically connecting the electronic components 650, 652, 654, and 656 mounted thereon to the terminal portion 622 of the connector 620. The filter unit 610 is provided at a predetermined position of the transmission line 640. The filter unit 610 may be provided on the substrate 630, or may also be provided so as to be located inside the connector 620.

The filter unit 610 may have the same configuration as any of the filter units described in the above-described embodiments. In this case, the identification device 100 (see FIG. 6) is provided, for example, in a device with which the in-vehicle device 600 communicates. Accordingly, when a wire harness connected to the in-vehicle device 600 has been removed, and another device is connected to the wire harness, it is possible to detect connection of an unauthorized device.

In the above-described embodiments, examples are described in which an identification device is provided in an ECU, and the diagnosis function of the ECU is used for identification of a wire harness or an in-vehicle device. However, the present disclosure is not limited to such embodiments. The identification device may also be configured not to use the diagnosis function of the ECU. The identification device may also be configured to be mounted in a vehicle as a dedicated in-vehicle device used for identification of a wire harness or an in-vehicle device.

In the above-described embodiments, the filter units may also be provided at a plurality of locations of the wire harness. Similarly, the filter units may also be provided at a plurality of locations of the in-vehicle device. Furthermore, in the above-described first to fourth embodiments, an identification transmission line that is not used for communication may also be provided in the wire harness, and the filter unit may also be provided on the identification transmission line.

In the above-described embodiments, examples are described in which the identification of the wire harness or the in-vehicle device is performed using the TDR method. However, the present disclosure is not limited to such embodiments. Methods other than the TDR method may also be used as long as the identification of the wire harness or the in-vehicle device can be performed based on the presence or absence of the filter unit.

In the above-described embodiments, an example is described in which the filter unit is configured to have a characteristic outside the communication band. However, the present disclosure is not limited to such an embodiment. The filter unit may also be configured to have a characteristic in the communication band. For example, the filter unit may also be configured such that at least a portion of the resonance frequency band of the filter unit is included in the communication band. Even when the frequency characteristic band formed by the line width of the transmission line or the stub overlaps a portion of the frequency band used, this does not pose any particular problem as long as the overlapping does not cause distortion of a communication waveform or a signal error. That is, some impedance mismatching is allowable within a range (within an allowable range) that does not affect the quality of communication signals.

The filter unit may also have a configuration other than the configurations described in the above-described embodiments. For example, the filter unit may also be configured using an electronic component such as a capacitor.

Embodiments that can be achieved by appropriately combining the techniques disclosed above also fall within the technical scope of the present disclosure.

The presently disclosed embodiments are merely illustrative, and the present disclosure is not limited to only the above-described embodiments. The scope of the present disclosure is defined by the claims in consideration of the detailed description of the disclosure, and includes all modifications which fall within the meaning and scope equivalent to the wording recited therein.

1. A wire harness configured to connect communication between a first communication unit and a second communication unit, the wire harness comprising:
a transmission line provided between the first communication unit and the second communication unit, and configured to transmit a signal from at least one of the first communication unit and the second communication unit; and
a filter unit provided at a predetermined position of the transmission line, and having a predetermined characteristic.

2. The wire harness according to claim 1, wherein
the filter unit is configured to filter a signal outside a communication band used for communication between the first communication unit and the second communication unit.

3. The wire harness according to claim 1, wherein
the transmission line includes a line that is not used for communication between the first communication unit and the second communication unit.

4. The wire harness according to claim 1, wherein
the filter unit includes an open stub having a predetermined length, and
the predetermined characteristic includes a capacitive reflection characteristic.

5. The wire harness according to claim 1, wherein
the filter unit includes a plurality of open stubs having predetermined lengths, and
the plurality of open stubs are respectively provided at predetermined positions of the transmission line.

6. The wire harness according to claim 5, wherein
the lengths of the plurality of open stubs are different from each other.

7. The wire harness according to claim 1, wherein
the filter unit is configured to have the predetermined characteristic by varying a line width of the transmission line.

8. The wire harness according to claim 7, wherein
the filter unit includes a filter region having an inductive reflection characteristic, or a filter region having a capacitive reflection characteristic.

9. The wire harness according to claim 1, wherein
the filter unit includes a plurality of filters having different reflection characteristics.

10. The wire harness according to claim 1, wherein
the filter unit is provided at a predetermined position of the transmission line.

11. The wire harness according to claim 10, further comprising
a connector provided at an end portion of the transmission line, wherein
the filter unit is located inside the connector.

12. The wire harness according to claim 1, further including;
a sheet-shaped holding member configured to hold the transmission line.

13. A harness identification system comprising:
a wire harness; and
an identification device configured to identify whether the wire harness is legitimate, wherein
the wire harness includes:
a transmission line configured to transmit a signal; and
a filter unit provided at a predetermined position of the transmission line, and having a predetermined characteristic,
the identification device includes:
a signal transmission unit configured to transmit an identification signal to the transmission line;
a signal reception unit configured to receive a reflection waveform of the identification signal; and
an identification unit configured to identify authenticity of the wire harness, based on whether a signal generated by the filter unit and having the predetermined characteristic is included in the received reflection waveform.

14. An in-vehicle device configured to be mounted in a vehicle, the in-vehicle device comprising:
a connector to which a wire harness is connected;
a substrate on which an electronic component is mounted;
a transmission line configured to transmit a signal between the electronic component and the wire harness; and
a filter unit provided at a predetermined position of the transmission line, and having a predetermined characteristic.
